(19) United States
(12) Patent Application Publication
(10) Pub. No.: US 2026/0302023 A1
(43) Pub. Date: Oct. 1, 2026

(54) Magnetic Fluid Composition

(71) Applicant: SEIKO EPSON CORPORATION, Tokyo (JP)

(72) Inventors: Takeshi YANO, Fujimi (JP); Daisuke ISHIHARA, Matsumoto (JP); Shigeki KAWADA, Shiojiri (JP)

(21) Appl. No.: 19/576,192

(22) Filed: Mar. 24, 2026

(30) Foreign Application Priority Data
Mar. 25, 2025 (JP) 2025-049277

(51) Int. Cl. H01F 1/44

(52) U.S. Cl. CPC H01F 1/442

(57) ABSTRACT

Provided is a magnetic fluid composition including: a metal magnetic particle; a nonmagnetic particle; and an ionic liquid, in which the ionic liquid contains a cationic group and an anionic group, the cationic group is one or more selected from the group including a quaternary ammonium ion, an imidazolium ion, a pyridinium ion, and a phosphonium ion, the anionic group is one or more selected from the group including a bis(fluorosulfonyl)amide ion, a (fluorosulfonyl(trifluoromethanesulfonyl)amide ion, a bis(pentafluoroethylsulfonyl)amide ion, a tris(trifluoromethanesulfonyl)methide ion, a trifluoromethanesulfonate ion, a thiocyanate ion, and a dicyanamide ion, and a volume average particle diameter of the nonmagnetic particle is more than 10 nm and 800 nm or less.

The present application is based on, and claims priority from JP Application Serial Number 2025-049277, filed Mar. 25, 2025, the disclosure of which is hereby incorporated by reference herein in its entirety.

### BACKGROUND

### 1. Technical Field

The present disclosure relates to a magnetic fluid composition.

### 2. Related Art

A magneto rheological fluid (also referred to as an “MR fluid”) is a fluid in which metal magnetic particles are dispersed in a dispersion medium such as mineral oil or silicone oil. When a magnetic field is applied to the magneto rheological fluid, the metal magnetic particles are magnetized and arranged in a magnetic field direction, forming chain-shaped clusters, which changes the viscosity of the fluid. A formation strength of the chain-shaped clusters depends on a magnitude of the magnetic field to be applied, and the viscosity can be varied by changing the magnitude of the magnetic field.

When the magnetic field is removed, the magnetization of the metal magnetic particles is released, the chain-shaped clusters return to an original non-oriented state, and the viscosity also returns to an original state. The viscosity of the fluid can be adjusted by repeating application and removal of the magnetic field to or from the magneto rheological fluid or changing the strength of the magnetic field. Therefore, the magneto rheological fluid is considered for use in a variety of fields, including control devices such as linear dampers and rotary dampers, and braking devices such as brakes and clutches.

A high braking force is required for the magneto rheological fluid used in the braking devices. A temperature range in which the magneto rheological fluid is used is assumed to be from minus several tens of degrees to several hundreds of degrees, and it is required that physical properties can be maintained not only at a room temperature but also at a low temperature or a high temperature.

For example, JP-T-2010-504635 discloses a method of using an ionic liquid as a dispersion medium as a solution to prevent evaporation of a magneto rheological fluid, assuming that the magneto rheological fluid is used at a high temperature of 200° C.

JP-T-2010-504635 is an example of the related art.

As the range of applications of the magneto rheological fluid expands, there is a demand for a magneto rheological fluid that not only has a high braking force but is also less likely to be affected by a surrounding environmental temperature.

### SUMMARY

The present disclosure has been made in view of the above circumstances, and an object thereof is to provide a magnetic fluid composition that can implement a high braking force and is less likely to be affected by a surrounding environmental temperature.

That is, the present disclosure includes the following aspects.

[1] A magnetic fluid composition including: a metal magnetic particle; a nonmagnetic particle; and an ionic liquid, in which the ionic liquid contains a cationic group and an anionic group, the cationic group is one or more selected from the group including a quaternary ammonium ion, an imidazolium ion, a pyridinium ion, and a phosphonium ion, the anionic group is one or more selected from the group including a bis(fluorosulfonyl)amide ion, a (fluorosulfonyl(trifluoromethanesulfonyl)amide ion, a bis(pentafluoroethylsulfonyl)amide ion, a tris(trifluoromethanesulfonyl)methide ion, a trifluoromethanesulfonate ion, a thiocyanate ion, and a dicyanamide ion, and
a volume average particle diameter of the nonmagnetic particle is more than 10 nm and 800 nm or less.

[2] The magnetic fluid composition according to [1], in which the nonmagnetic particle is an inorganic material.

[3] The magnetic fluid composition according to [1] or [2], in which a content ratio of the nonmagnetic particle with respect to a total amount of the magnetic fluid composition is 0.01% by mass or more and 5% by mass or less.

[4] The magnetic fluid composition according to any one of [1] to [3], in which the magnetic fluid composition has a yield stress of 15 kPa or more when being applied with a magnetic field of 0.6 T.

[5] The magnetic fluid composition according to any one of [1] to [4], in which the magnetic fluid composition has a boiling point of 250° C. or higher and a freezing point of 0° C. or lower.

[6] The magnetic fluid composition according to any one of [1] to [5], in which the cationic group is a cation of any of the following (A)-1, (A)-2, (A)-3, (A)-20, (B)-1, (C)-1, (D)-1, (D)-2, and (D)-3:

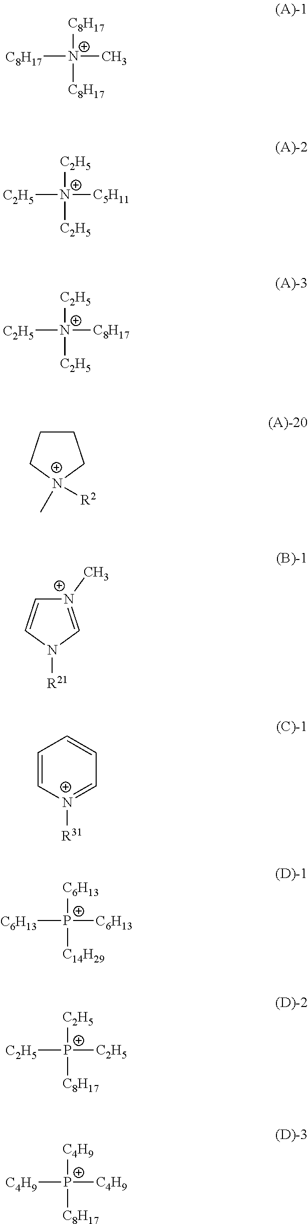

in the above formula, R² represents a linear or branched alkyl group having 1 to 5 carbon atoms, R²¹ represents an alkyl group having 4 to 6 carbon atoms, and R³¹ represents an alkyl group having 4 to 8 carbon atoms.

According to the present disclosure, a magneto rheological fluid that can implement a high braking force and is less likely to be affected by a surrounding environmental temperature can be provided.

### DESCRIPTION OF EMBODIMENTS

### Magnetic Fluid Composition

The present disclosure relates to a magnetic fluid composition including metal magnetic particles, nonmagnetic particles, and an ionic liquid.

Each component will be described below.

### Metal Magnetic Particles

The metal magnetic particles in the present specification are particles containing, as a forming material, a metal material exhibiting paramagnetism. The metal magnetic particles are a paramagnetic material as a whole. A material constituting the magnetic particles contains a metal element, and preferably contains at least one metal element selected from the group including Fe, Ni, and Co.

The above metal element may be contained in the metal magnetic particles as a magnetic alloy, a magnetic metal oxide, a magnetic metal nitride, or a magnetic metal carbide.

The materials constituting the metal magnetic particles may contain an element other than Fe, Ni, and Co, and specific examples thereof include Al, Si, S, Sc, Ti, V, Cu, Y, Mo, Rh, Pd, Ag, Sn, Sb, Te, Ba, Ta, W, Re, Au, Bi, La, Ce, Pr, Nd, P, Zn, Sr, Zr, Mn, Cr, Nb, Pb, Ca, B, C, and N.

Specific examples of the materials constituting the metal magnetic particles include alloys such as an Fe—Co-based alloy (preferably permendur), an Fe—Ni-based alloy (preferably permalloy), an Fe—Zr-based alloy, an Fe—Mn-based alloy, an Fe—Si-based alloy, an Fe—Al-based alloy, a Ni—Mo-based alloy (preferably supermalloy), an Fe—Ni—Co-based alloy, an Fe—Si—Cr-based alloy, an Fe—Si—B-based alloy, an Fe—Si—Al-based alloy (preferably sendust), an Fe—Si—B—C-based alloy, an Fe—Si—B—Cr-based alloy, an Fe—Si—B—Cr—C-based alloy, an Fe—Co—Si—B-based alloy, an Fe—Si—B—Nb-based alloy, an Fe nano crystal alloy, an Fe-based amorphous alloy, and a Co-based amorphous alloy, and ferrite such as spinel ferrite (preferably Ni—Zn-based ferrite or Mn—Zn-based ferrite) and hexagonal ferrite (preferably barium ferrite).

The above alloy may be an amorphous alloy.

Among them, the amorphous alloy is preferred, and the Fe—Si—B—Cr—C-based alloy, the Fe-based amorphous alloy, the Fe—Si—Cr-based alloy, the Fe nano crystal alloy, the Fe—Ni—Co-based alloy, the Co-based amorphous alloy, and the Ni—Mo-based alloy are furthermore preferred.

The materials constituting the metal magnetic particles may be used alone or may be used in combination of two or more types.

A content ratio of the metal magnetic particles in the magnetic fluid composition is, for example, 10% by mass or more and 99% by mass or less and 20% by mass or more and 90% by mass or less with respect to a total mass of the magnetic fluid composition.

When two or more types of the metal magnetic particles are contained, the above content ratio is a total content ratio of two or more types of metal composite particles.

### Nonmagnetic Particles

In a general magnetic fluid composition, the metal magnetic particles are dispersed in a dispersion medium such as mineral oil or silicone oil.

Since a difference in specific gravity between a general dispersion medium such as mineral oil or silicone oil and metal magnetic particles in the magnetic fluid composition is large, the metal magnetic particles tend to settle. The settled metal magnetic particles tend to aggregate and become in a state of separating from the dispersion medium. When the metal magnetic particles settle and separate, the required yield stress is not exerted and the braking force is reduced.

Fine particles in a liquid diffuse into the dispersion medium due to random Brownian motion. Further, fine particles in the dispersion medium settle by gravity, but if the diffusion effect due to Brownian motion is greater than a settling velocity of the particles, the fine particles do not settle and can maintain a diffused state.

The nonmagnetic particles having a volume average particle diameter of more than 10 nm and 800 nm or less are less likely to settle in the dispersion medium due to Brownian motion and are likely to maintain a diffused state. Since the diffused nonmagnetic particles inhibit the settling of the metal magnetic particles, the metal magnetic particles can be maintained in a dispersed state.

The volume average particle diameter of the nonmagnetic particles is preferably 12 nm or more and 600 nm or less, and more preferably 14 nm or more and 550 nm or less.

When the volume average particle diameter of the nonmagnetic particles is equal to or less than the above upper limit value, the diffusion effect due to Brownian motion is greater than the settling velocity of the particles, and the nonmagnetic particles are maintained in a diffused state.

When the volume average particle diameter of the nonmagnetic particles is equal to or larger than the above lower limit value, settling of the metal magnetic particles is likely to be inhibited.

An effect of the nonmagnetic particles in preventing the settling of the metal magnetic particles is exerted by the volume average particle diameter, so a material thereof is not particularly limited, and nonmagnetic inorganic material, a thermoplastic resin, and a thermosetting resin can be used.

Examples of the nonmagnetic inorganic material include nonmagnetic metals (such as gold, silver, copper, palladium, and platinum), ceramics (such as, metal oxides, metal nitrides, metal carbides, metal carbonates, metal halides, metal phosphate, and metal sulfates), carbon black, and graphite.

Examples of the metal oxide include alumina, silica, titanium oxide, zinc oxide, calcium oxide, magnesium oxide, tin dioxide, silicon dioxide, nonmagnetic chromium oxide, cerium oxide, and nonmagnetic iron oxide. Examples of the metal carbide include silicon carbide, molybdenum carbide, boron carbide, tungsten carbide, and titanium carbide. Examples of the metal carbonate include magnesium carbonate and calcium carbonate.

Examples of the metal nitride include boron nitride and silicon nitride.

Examples of the metal halide include calcium fluoride, sodium fluoride, potassium fluoride, cesium fluoride, and lithium chloride.

Examples of the metal sulfate include barium sulfate and calcium sulfate.

Examples of the thermoplastic resin include a polyester resin, a vinyl resin (such as an acrylic resin, a polystyrene resin, a polyvinyl acetate resin, and a polyvinyl chloride resin), an ABS resin, and an AS resin.

Examples of the thermosetting resin include a phenol resin, an epoxy resin, a melamine resin, a urea resin, an unsaturated polyester resin, and an alkyd resin.

A content ratio of the nonmagnetic particles with respect to a total amount of the magnetic fluid composition is preferably 0.01% by mass or more and 5% by mass or less, more preferably 0.1% by mass or more and 3% by mass or less, and still more preferably 0.5% by mass or more and 2% by mass or less.

When the content ratio of the nonmagnetic particles is equal to or larger than the above lower limit value, settling of the metal magnetic particles is likely to be inhibited.

When the content ratio of the nonmagnetic particles is equal to or less than the above lower limit value, a dispersion state of the nonmagnetic particles is easily maintained.

### Ionic Liquid

The magnetic fluid composition includes an ionic liquid as the dispersion medium.

The ionic liquid contains a cationic group and an anionic group.

The cationic group is one or more selected from the group including ammonium ion, a quaternary an imidazolium ion, a pyridinium ion, and a phosphonium ion.

The anionic group is one or more selected from the group including a bis(fluorosulfonyl)amide ion, a (fluorosulfonyl(trifluoromethanesulfonyl)amide ion, a bis(pentafluoroethylsulfonyl)amide ion, a tris(trifluoromethanesulfonyl)methide ion, a trifluoromethanesulfonate ion, a thiocyanate ion, and a dicyanamide ion.

It was found that the ionic liquid including a combination of the above cationic group and anionic group does not evaporate even at 250° C. or higher and remains liquid even at 0° C. or lower.

The ionic liquid has a higher affinity with the metal magnetic particles than that with the mineral oil, and using the ionic liquid in the dispersion medium makes it difficult for the magnetic fluid composition to separate.

The cationic group and the anionic group will be described below.

### Cationic Group

### ·Quaternary Ammonium Ion

Examples of the quaternary ammonium ion include a cation represented by the following formula (A):

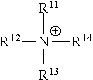

in Formula (A), R¹¹ to R¹⁴ each independently represents a linear or branched alkyl group having 1 to 20 carbon atoms. R¹¹ to R¹⁴ may be bonded to form a ring.

Examples of the linear alkyl group of R¹¹ to R¹⁴ include linear alkyl groups having 1 to 20 carbon atoms. Specific examples thereof include a methyl group, an ethyl group, a propyl group, a butyl group, a pentyl group, a hexyl group, a heptyl group, an octyl group, a nonyl group, a decanyl group, an undecyl group, a dodecyl group, a tridecyl group, a tetradecyl group, a pentadecyl group, a hexadecyl group, a heptadecyl group, an octadecyl group, a nonadecyl group, and an icosyl group.

Examples of the branched alkyl group of R¹¹ to R¹⁴ include branched alkyl groups having 3 to 20 carbon atoms. Specific examples thereof include a 1-methylethyl group, a 1-methylpropyl group, a 2-methylpropyl group, a 1-methylbutyl group, a 2-methylbutyl group, a 3-methylbutyl group, a 1-ethylbutyl group, a 2-ethylbutyl group, a 1 methylpentyl group, a 3-2-methylpentyl group, methylpentyl group, and a 4-methylpentyl group.

When R¹¹ to R¹⁴ are bonded to form a ring, examples of the formed ring include a cyclopropyl group, a cyclobutyl group, a cyclopentyl group, a cyclohexyl group, a cycloheptyl group, a cyclooctyl group, a cyclodecyl group, and a cyclododecyl group.

Specific examples of the quaternary ammonium ion include tetraethyl ammonium, tetramethyl ammonium, tetrapropyl ammonium, tetrabutyl ammonium, and tetrapentyl ammonium.

As the quaternary ammonium ion, a cation represented by the following (A)-1, (A)-2, or (A)-3 is more preferable.

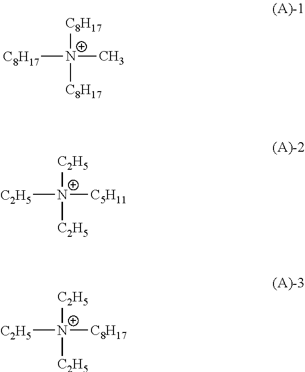

The quaternary ammonium ion may be a cation represented by the following (A)-20:

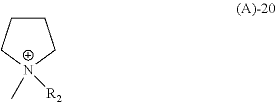

in the above formula, R² represents a linear or branched alkyl group having 1 to 5 carbon atoms.

The cation represented by (A)-20 is preferably a cation represented by the following (A)-20-1 or (A)-20-2.

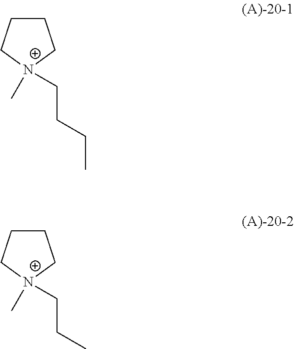

### ·Imidazolium Ion

Examples of the imidazolium ion include a cation represented by the following formula (B):

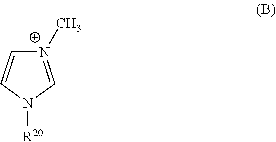

in Formula (B), R²⁰ is a linear or branched alkyl group having 1 to 20 carbon atoms.

The description related to the linear or branched alkyl group having 1 to 20 carbon atoms of R²⁰ in Formula (B) is the same as the description related to the linear or branched alkyl group having 1 to 20 carbon atoms of R¹¹ to R¹⁴ in above Formula (A).

As R²⁰, an alkyl group having 1 to 10 carbon atoms is preferable, and an alkyl group having 2 to 8 carbon atoms is further preferable.

As the imidazolium ion, a cation represented by the following formula (B)-1 is more preferable:

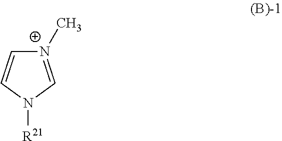

in Formula (B)-1, R²¹ is an alkyl group having 4 to 8 carbon atoms.

Examples of R²¹ include an n-butyl group, a sec-butyl group, an isobutyl group, a tert-butyl group, a pentyl group, a hexyl group, a heptyl group, and an octyl group.

### Pyridinium Ion

Examples of the pyridinium ion include a cation represented by the following formula (C):

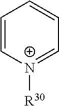

in Formula (C), R³⁰ is a linear or branched alkyl group having 1 to 20 carbon atoms.

The description related to the linear or branched alkyl group having 1 to 20 carbon atoms of R³⁰ in Formula (C) is the same as the description related to the linear or branched alkyl group having 1 to 20 carbon atoms of R¹¹ to R¹⁴ in above Formula (A).

As R³⁰, an alkyl group having 1 to 10 carbon atoms is preferable, and an alkyl group having 2 to 8 carbon atoms is more preferable.

As the pyridinium ion, a cation represented by the following formula (C)-1 is preferable:

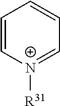

in Formula (C)-1, R³¹ is an alkyl group having 4 to 6 carbon atoms.

Examples of R³¹ include an n-butyl group, a sec-butyl group, an isobutyl group, a tert-butyl group, a pentyl group, and a hexyl group.

### ·Phosphonium Ion

Examples of the phosphonium ion include a cation represented by the following formula (D):

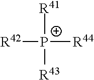

in formula (D), R⁴¹ to R⁴⁴ each independently represents a linear or branched alkyl group having 1 to 20 carbon atoms. R⁴¹ to R⁴⁴ may be bonded to form a ring.

The description related to the linear or branched alkyl group having 1 to 20 carbon atoms of R⁴¹ to R⁴⁴ in Formula (D) is the same as the description related to the linear or branched alkyl group having 1 to 20 carbon atoms of R¹¹ to R¹⁴ in above Formula (A).

As R⁴¹ to R⁴⁴, an alkyl group having 2 to 18 carbon atoms is preferable, and an alkyl group having 4 to 16 carbon atoms is more preferable.

Examples of the phosphonium ion include tetrabutylphosphonium, tetrapropylphosphonium, tetraethylphosphonium, tetramethylphosphonium, and hexadecyltributylphosphonium.

The phosphonium ion is preferably any cation of the following formulae (D)-1, (D)-2, and (D)-3.

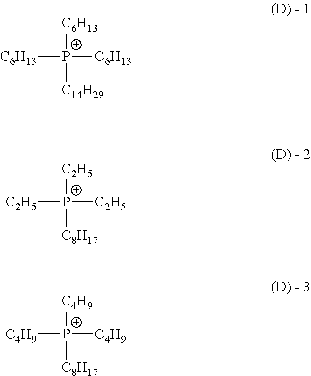

The cation is preferably a cation of any of the following (A)-1, (A)-2, (A)-3, (A)-20, (B)-1, (C)-1, (D)-1, (D)-2, and (D)-3:

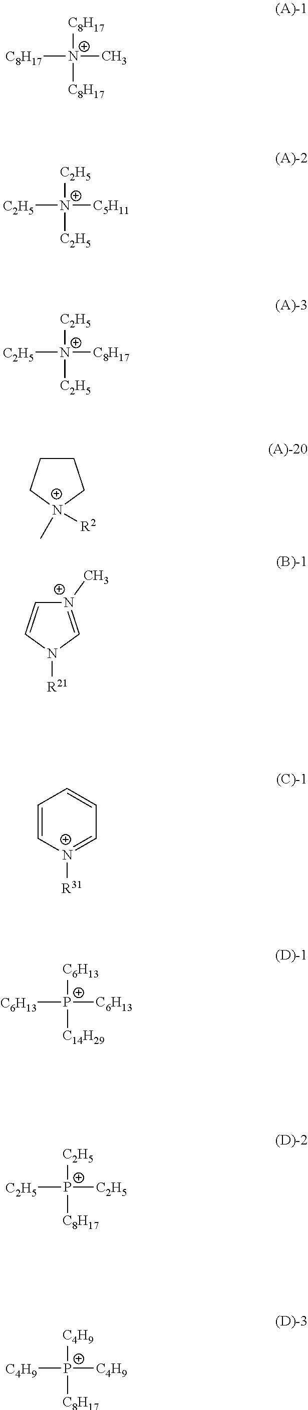

in the above formulae, R² represents a linear or branched alkyl group having 1 to 5 carbon atoms, R²¹ represents an alkyl group having 4 to 6 carbon atoms, and R³¹ represents an alkyl group having 4 to 8 carbon atoms.

### Anionic Group

The anionic group is one or more selected from the group including a bis(fluorosulfonyl)amide ion, a (fluorosulfonyl(trifluoromethanesulfonyl)amide ion, a bis(pentafluoroethylsulfonyl)amide ion, a tris(trifluoromethanesulfonyl)methide ion, a trifluoromethanesulfonate ion, a thiocyanate ion, and a dicyanamide ion.

Both the cationic group and the anionic group described above are bulky ions. From the study by the inventors of the present disclosure, it was found that a magnetic fluid composition using an ionic liquid obtained by combining the above bulky ions in a dispersion medium is less likely to evaporate even at a high temperature and remains liquid even at a low temperature.

The dispersion medium is preferably formed of the ionic liquid, and the dispersion medium may contain additives other than the ionic liquid in a range of not impairing the effects of the present disclosure. Examples of such an additive include thixotropic agents, surfactants, plastic media, and water-in-oil emulsions.

A content ratio of the ionic liquid with respect to the total amount of the magnetic fluid composition is preferably 5% by mass or more and 30% by mass or less, and more preferably 10% by mass or more and 20% by mass or less.

When the content ratio of the ionic liquid is in the above range, the dispersion state of the nonmagnetic particles is easily maintained.

### Physical Properties of Magnetic Fluid Composition

The magnetic fluid composition has a yield stress of preferably 15 kPa or more and more preferably 20 kPa or more when being applied with a magnetic field of 0.6 T. The yield stress of the magnetic fluid composition can be measured by methods described in examples.

A boiling point of the magnetic fluid composition is preferably 250° C. or higher, more preferably 300° C. or higher, and still more preferably 350° C. or higher. The boiling point of the magnetic fluid composition can be measured by methods described in examples.

A freezing point of the magnetic fluid composition is preferably 0° C. or lower, more preferably −10° C. or lower, and still more preferably −20° C. or lower. The freezing point of the magnetic fluid composition can be measured by methods described in examples.

### Method for Producing Magnetic Fluid Composition

The magnetic fluid composition according to the embodiment can be produced by mixing and stirring the metal magnetic particles, the nonmagnetic particles, and the ionic liquid at a desired ratio.

### EXAMPLE

### Production of Magnetic Fluid Composition

Magnetic fluid compositions of Examples 1 to 6 and Comparative Examples 1 to 12 were produced by mixing metal magnetic particles, nonmagnetic particles, and ionic liquids indicated in Tables 1 to 3 at the following ratios and stirring them under the following conditions.

### Mixing Ratio

Metal magnetic particles: 80% by mass
Nonmagnetic particles: 18 by mass
Ionic liquid: 19% by mass

### Stirring Conditions

Stirring was performed at 3000 rpm for 30 minutes using a high shear mixer (Silverson, L5M-A).

The boiling point, the freezing point, and the yield stress of the magnetic fluid composition were measured and evaluated by the following methods.

### Boiling Point

The magnetic fluid composition (2 mL) was heated on a hot plate, a temperature at which white smoke was generated was confirmed and evaluated according to the following criteria. Among the following criteria, if the criteria met A or B, it was evaluated that “the magnetic fluid composition has a high boiling point”.
A: No evaporation up to 350° C.
B: No evaporation up to 250° C.
C: Evaporated below 250° C.

### Freezing Point

The magnetic fluid composition (2 mL) was cooled by a refrigerator, and a solidification temperature was confirmed and evaluated according to the following criteria. Among the following criteria, if the criteria met A or B, it was evaluated that “the magnetic fluid composition has a low freezing point”.
A: Solidify at −20° C. or lower
B: Solidify at higher than −20° C. and 0° C. or lower
C: Solidify at higher than 0° C. and 10° C. or lower

### Yield Stress

At 250° C., the yield stress of the magnetic fluid composition when being applied with a magnetic field having a shear stress of 333/sec and a magnetic flux density of 0.6 T was measured and evaluated according to the following criteria. Among the following criteria, if the criteria met A or B, it was evaluated that “the magnetic fluid composition has a high braking force”.
A: 20 kPa or more
B: 15 kPa or more and less than 20 kPa
C: 10 kPa or more and less than 15 kPa

| No. | | Example 1 | Example 2 | Example 3 |
|---|---|---|---|---|
| Metal magnetic | Magnetic powder | Fe, S5, B, C, Cr | Fe, S5, B, C, Cr | Fe, S5, B, C, Cr |
| particles | Steel type | Amorphous alloy | Amorphous alloy | Amorphous alloy |
| Ionic liquid | Type of cation ion | Ammonium | Ammonium | Phosphonium |
| | Structure of cation ion | (A)-2 | (A)-3 | (D)-1 |
| | Anion ion | Bis(trifluoromethane | Bis(trifluoromethane | Dicyanamide |
| | | sulfonyl)amide | sulfonyl)amide | |
| Nonmagnetic | Nonmagnetic | Silica | Silica | Silica |
| particles | particles | | | |
| | Particle | 40 | 40 | 40 |
| | diameter (nm) | | | |
| Physical properties | Boiling point | A | A | A |
| of magneto | Freezing point | A | A | A |
| rheological fluid | Yield stress | A | A | A |
| composition | | | | |

| | | | |
|---|---|---|---|
| No. | Example 4 | Example 5 | Example 6 |

| | | | | |
|---|---|---|---|---|
| Metal magnetic | Magnetic powder | Fe, S5, B, C, Cr | Fe, S5, B, C, Cr | Fe, S5, B, C, Cr |
| particles | Steel type | Amorphous alloy | Amorphous alloy | Amorphous alloy |
| Ionic liquid | Type of cation ion | Phosphonium | Phosphonium | Phosphonium |
| | Structure of cation ion | (D)-2 | (D)-3 | (D)-3 |
| | Anion ion | Bis(trifluoromethane | Tetrafluoroboric | Thiocyanate |
| | | sulfonyl)amide | acid | |
| Nonmagnetic | Nonmagnetic | Silica | Silica | Silica |
| particles | particles | | | |
| | Particle | 40 | 40 | 40 |
| | diameter (nm) | | | |
| Physical properties | Boiling point | A | A | A |
| of magneto | Freezing point | A | A | A |
| rheological fluid | Yield stress | A | A | A |
| composition | | | | |

| | | Comparative | Comparative | Comparative |
|---|---|---|---|---|
| No. | | Example 1 | Example 2 | Example 3 |
| Metal magnetic | Magnetic powder | Fe, Si, B, C, Cr | Fe, Si, B, C, Cr | Fe, Si, B, C, Cr |
| particles | Steel type | Amorphous alloy | Amorphous alloy | Amorphous alloy |
| Ionic liquid | Type of cation ion | Hydrocarbon oil | Imidazolium | Imidazolium |
| | Structure of cation ion | | (B)-1-8 | (B)-1-2 |
| | Anion ion | | Hexafluorophosphate | Bis(trifluoromethane |
| | | | | sulfonyl)amide |
| Nonmagnetic | Nonmagnetic particles | Silica | — | Silica |
| particles | Particle diameter (nm) | 500 | — | 3000 |
| Physical properties | Boiling point | C | A | B |
| of magneto | Freezing point | B | A | A |
| rheological fluid | Yield stress | C | C | C |
| composition | | | | |

| | | Comparative | Comparative | Comparative |
|---|---|---|---|---|
| No. | | Example 4 | Example 5 | Example 6 |
| Metal magnetic | Magnetic powder | Fe, Si, B, C, Cr | Fe, Si, B, C, Cr | Fe, Si, B, C, Cr |
| particles | Steel type | Amorphous alloy | Amorphous alloy | Amorphous alloy |
| Ionic liquid | Type of cation ion | Imidazolium | Imidazolium | Imidazolium |
| | Structure of cation ion | (B)-1-2 | (B)-1-2 | (B)-1-8 |
| | Anion ion | Bis(trifluoromethane | Bis(trifluoromethane | Hexafluorophosphate |
| | | sulfonyl)amide | sulfonyl)amide | |
| Nonmagnetic | Nonmagnetic particles | Molybdenum | Silica | Nylon polymer |
| particles | | disulfide | | |
| | Particle diameter (nm) | 1400 | 7 | 5000 |
| Physical properties | Boiling point | B | B | A |
| of magneto | Freezing point | A | A | A |
| rheological fluid | Yield stress | C | C | C |
| composition | | | | |

| | | Comparative | Comparative | Comparative |
|---|---|---|---|---|
| No. | | Example 7 | Example 8 | Example 9 |
| Metal magnetic | Magnetic powder | Fe, Si, B, C, Cr | Fe, Si, B, C, Cr | Fe, Si, B, C, Cr |
| particles | Steel type | Amorphous alloy | Amorphous alloy | Amorphous alloy |
| Ionic liquid | Type of cation ion | Imidazolium | Imidazolium | Ammonium |
| | Structure of cation ion | (B)-1-8 | (B)-1-8 | (A)-1 |
| | Anion ion | Hexafluorophosphate | Hexafluorophosphate | Trifluoromethanesulfonic acid |
| Nonmagnetic | Nonmagnetic particles | Fluoropolymer | Acryl polymer | Silica |
| particles | Particle diameter (nm) | 300 | 80 | 500 |
| Physical properties | Boiling point | A | A | C |
| of magneto | Freezing point | A | A | C |
| rheological fluid | Yield stress | C | C | B |
| composition | | | | |

| | | Comparative | Comparative | Comparative |
|---|---|---|---|---|
| No. | | Example 10 | Example 11 | Example 12 |
| Metal magnetic | Magnetic powder | Fe, Si, B, C, Cr | Fe, Si, B, C, Cr | Fe, Si, B, C, Cr |
| particles | Steel type | Amorphous alloy | Amorphous alloy | Amorphous alloy |
| Ionic liquid | Type of cation ion | Imidazolium | Imidazolium | Pyridinium |
| | Structure of cation ion | (B)-1-1 | (B)-1-16 | (C)-1-4 |
| | Anion ion | Trifluoromethanesulfonic acid | Chloride | Bromide |
| Nonmagnetic | Nonmagnetic particles | Silica | Silica | Silica |
| particles | Particle diameter (nm) | 500 | 500 | 500 |
| Physical properties | Boiling point | A | C | B |
| of magneto | Freezing point | C | C | C |
| rheological fluid | Yield stress | B | B | B |
| composition | | | | |

Structures of cation ions in Tables 1 to 3 are indicated below.

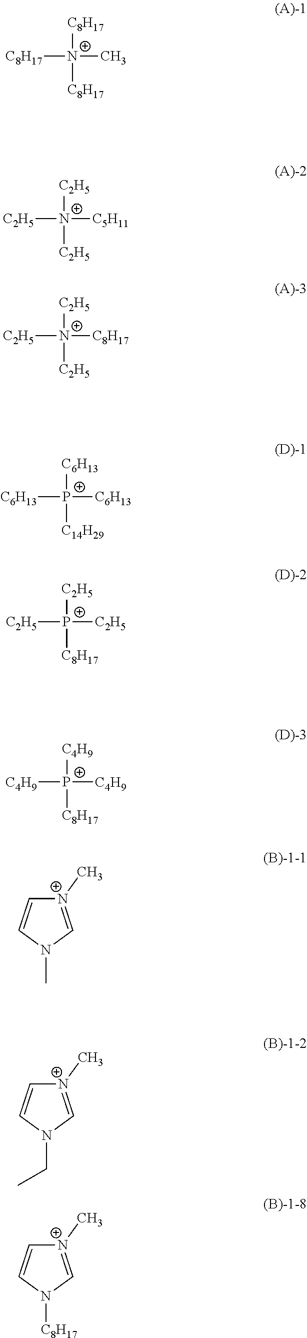

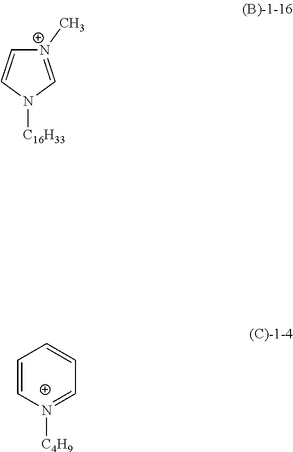

As indicated in the above results, in Examples 1 to 6, the yield stress was all A, and it was confirmed that a high braking force can be achieved. In addition, in Examples 1 to 6, the results of the boiling point and the freezing point were all A, and it was confirmed that the compositions were difficult to evaporate at a high temperature and difficult to solidify at a low temperature. Therefore, it was confirmed that the magnetic fluid compositions in Examples 1 to 6 can achieve a high braking force and are less likely to be affected by the surrounding environmental temperature.

In Comparative Example 1 in which the ionic liquid was not used in the dispersion medium but hydrocarbon oil was used, it was considered that the affinity between the metal magnetic particles and the dispersion medium is insufficient, and the yield stress is insufficient because the magnetic fluid composition was separated.

In Comparative Example 2 in which the nonmagnetic particles were not contained and Comparative Examples 3 to 5 in which a particle diameter of the nonmagnetic particles did not satisfy the present disclosure, it was considered that the metal magnetic particles settle and the yield stress is insufficient because the magnetic fluid composition was separated.

In Comparative Examples 6 to 8 in which a polymer having low heat resistance was used as the nonmagnetic particles, since the polymer was dissolved by heating during the measurement of the yield stress, the metal magnetic particles settle, and it was considered that the yield stress is insufficient because the magnetic fluid composition is separated.

In Comparative Examples 9 to 12 in which an ionic liquid containing a bulky anionic group was used, it was confirmed that the freezing point is high and solidification was easy at a low temperature.

What is claimed is:

1. A magnetic fluid composition comprising:
a metal magnetic particle;
a nonmagnetic particle; and
an ionic liquid, wherein
the ionic liquid contains a cationic group and an anionic group,
the cationic group is one or more selected from the group including a quaternary ammonium ion, an imidazolium ion, a pyridinium ion, and a phosphonium ion,
the anionic group is one or more selected from the group including a bis(fluorosulfonyl)amide ion, a (fluorosulfonyl(trifluoromethanesulfonyl)amide ion, a bis(pentafluoroethylsulfonyl)amide ion, a tris(trifluoromethanesulfonyl)methide ion, a trifluoromethanesulfonate ion, a thiocyanate ion, and a dicyanamide ion, and
a volume average particle diameter of the nonmagnetic particle is more than 10 nm and 800 nm or less.

2. The magnetic fluid composition according to claim 1, wherein
the nonmagnetic particle is an inorganic material.

3. The magnetic fluid composition according to claim 1, wherein
a content ratio of the nonmagnetic particle with respect to a total amount of the magnetic fluid composition is 0.01% by mass or more and 5% by mass or less.

4. The magnetic fluid composition according to claim 1, wherein
the magnetic fluid composition has a yield stress of 15 kPa or more when being applied with a magnetic field of 0.6 T.

5. The magnetic fluid composition according to claim 1, wherein
the magnetic fluid composition has a boiling point of 250° C. or higher and a freezing point of 0° C. or lower.

6. The magnetic fluid composition according to claim 1, wherein
the cationic group is a cation of any of the following (A)-1, (A)-2, (A)-3, (A)-20, (B)-1, (C)-1, (D)-1, (D)-2, and (D)-3: 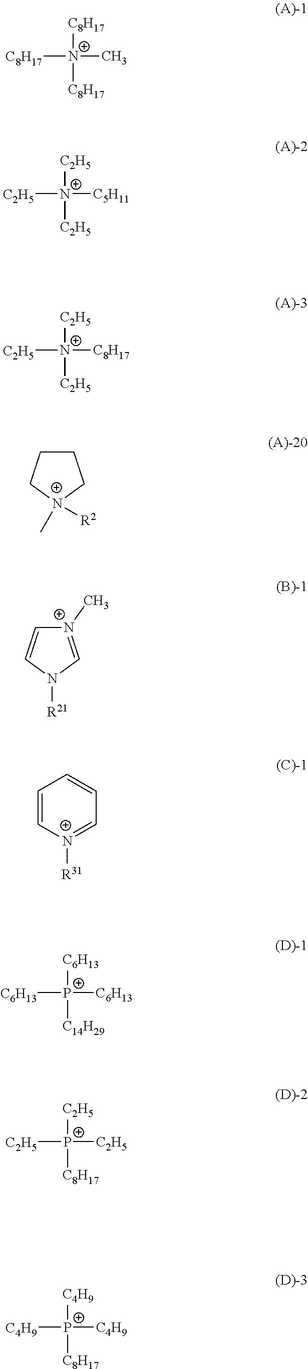
in the above formula, R² represents a linear or branched alkyl group having 1 to 5 carbon atoms, R²¹ represents an alkyl group having 4 to 6 carbon atoms, and R³¹ represents an alkyl group having 4 to 8 carbon atoms.
